(19) United States
(12) Patent Application Publication
(10) Pub. No.: US 2008/0254185 A1
(43) Pub. Date: Oct. 16, 2008

(54) Sweetener Compositions Having Improved Taste

(75) Inventors: Yukimi Yamakawa, Yokohama City (JP); Haruko Shimada, Sayama City (JP)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/756,528

(22) Filed: May 31, 2007

Related U.S. Application Data
(60) Provisional application No. 60/911,655, filed on Apr. 13, 2007.

(51) Int. Cl. A23L 2/60; A23L 1/236

(52) U.S. Cl. 426/548

(57) ABSTRACT

This invention provides a sweetener composition having improved taste. In a particular embodiment, the sweetener composition comprises at least one synthetic sweetener and at least one magnesium salt. Desirably, the at least one synthetic sweetener comprises aspartame, acesulfame-K, sucralose, or combinations thereof and the at least one magnesium salt comprises magnesium chloride or magnesium sulfate. Also provided herein are methods for the formulation and uses of the sweetener compositions having improved taste.

### RELATED APPLICATION DATA

The present application claims the benefit of priority under 35 U.S.C. §119(e) to U.S. Provisional Application No. 60/911,655, filed on Apr. 13, 2007, the disclosure of which is incorporated herein by reference in its entirety.

### FIELD OF THE INVENTION

This invention is related to sweetener compositions having improved taste, methods for their formulation, and uses.

### BACKGROUND OF THE INVENTION

Low calorie beverages and food products have become more important with increased health awareness and sedentary lifestyles. However, alternative non-caloric or low-caloric sweeteners that generally are used as sugar or sucrose substitutes (e.g., saccharin, aspartame, and sucralose) possess taste characteristics different than that of sugar, such as sweet tastes with different temporal profiles, maximal responses, flavor profiles, mouthfeels, and/or adaptation behaviors than that of sugar. For example, the sweet tastes of synthetic high-potency sweeteners are slower in onset and longer in duration than the sweet taste produced by sugar and thus change the taste balance of a food composition. Because of these differences, use of a synthetic high-potency sweetener to replace a bulk sweetener, such as sugar, in a food or beverage, causes an unbalanced temporal profile and/or flavor profile. If the taste profile of synthetic high-potency sweeteners could be modified to impart specific desired taste characteristics to synthetic high-potency non-caloric or low-caloric sweeteners, low calorie beverages and food products comprising such synthetic high-potency sweeteners could be provided that have taste characteristics that are desirable to consumers. Accordingly, it would be desirable to selectively modify the taste characteristics of synthetic high-potency sweeteners.

Thus, there is a need to provide a non-caloric or low-caloric sweetener composition having improved taste and methods thereof. There is an additional need in the art to provide a non-caloric or low-caloric sweetener composition with a more sugar-like taste and methods thereof.

### SUMMARY OF THE INVENTION

Generally, this invention provides a sweetener composition having improved taste. In a particular embodiment, the sweetener composition having improved taste comprises at least one synthetic sweetener and a magnesium salt. In particularly desirable embodiments, the at least one synthetic sweetener is selected from the group consisting of aspartame, acesulfame K, sucralose, and combinations thereof and the at least one magnesium salt is selected from the group consisting of magnesium chloride, magnesium sulfate, and combinations thereof. In another particular embodiment, the sweetener composition further comprises at least one inorganic salt different than the at least one magnesium salt, such as sodium chloride.

Also provided are sweetened compositions comprising the sweetener compositions described herein. In a particular embodiment, the sweetened composition comprises a beverage.

Objects and advantages of the invention will be set forth in part in the following description, or may be obvious from the description, or may be learned through practice of the invention. Unless otherwise defined, all technical and scientific terms and abbreviations used herein have the same meaning as commonly understood by one of ordinary skill in the art to which this invention pertains. Although methods and compositions similar or equivalent to those described herein can be used in the practice of the present invention, suitable methods and compositions are described without intending that any such methods and compositions limit the invention herein.

### DETAILED DESCRIPTION OF THE INVENTION

Reference now will be made in detail to the presently proffered embodiments of the invention. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment, can be used on another embodiment to yield a still further embodiment. Thus, it is intended that the present invention cover such modifications and variations within the scope of the appended claims and their equivalents.

This invention addresses the above-identified needs by providing a sweetener composition having improved taste characteristics. Generally, the sweetener composition comprises at least one synthetic sweetener in combination with at least one magnesium salt.

The phrase synthetic sweeteners, as used herein, refers to any compositions which are not found in nature and which have sweetness, preferably with a sweetness potency greater than sucrose, fructose, or glucose, yet have less calories. In a particular embodiment, the at least one synthetic sweetener is selected from the group consisting of aspartame, acesulfame K, sucralose, and combinations thereof. Other synthetic sweeteners also may be used, non-limiting examples of which include alitame, saccharin, neohesperidin dihydrochalcone, cyclamate, neotame, N-[3-(3-hydroxy-4-methoxyphenyl)propyl]-L-α-aspartyl]-L-phenylalanine 1-methyl ester, N-[3-(3-hydroxy-4-methoxyphenyl)-3-methylbutyl]-L-α-aspartyl]-L-phenylalanine 1-methyl ester, N-[3-(3-methoxy-4-hydroxyphenyl)propyl]-L-α-aspartyl]-L-phenylalanine 1-methyl ester, salts thereof, and the like.

It also is envisioned that natural high-potency sweeteners may be used as a substitute or in combination with the synthetic sweeteners described hereinabove. Non-limiting examples of suitable non-caloric and low-caloric natural high-potency sweeteners include rebaudioside A, rebaudioside B, rebaudioside C (dulcoside B), rebaudioside D, rebaudioside E, rebaudioside F, dulcoside A, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

In a particular embodiment, the sweetener composition comprises a combination of the synthetic sweeteners aspartame, acesulfame-K, and sucralose. The synthetic sweeteners desirably are present in the sweetener composition at a weight ratio from about 1 part aspartame to about 0.25 to about 2.0 parts acesulfame-K to about 0.25 to about 1.0 parts sucralose.

In another particular embodiment, the sweetener composition comprises a combination of the synthetic sweeteners acesulfame-K and sucralose. In one embodiment, the synthetic sweeteners are present in the sweetener composition at a weight ratio from about 0.5 to about 3.0 parts acesulfame-K to about 1 part sucralose.

Magnesium salts, as used herein, comprise both acid and base addition salts formed with magnesium. Non-limiting examples of suitable magnesium salts include magnesium chloride, magnesium sulfate, and magnesium phosphate.

In a particular embodiment, the at least one magnesium salt comprises magnesium chloride. In one embodiment, the magnesium chloride is present in the sweetener composition at a weight ratio from about 0.07 to about 15 parts magnesium chloride on a dry basis to about 1 part synthetic sweetener. In another embodiment, the magnesium chloride is present in the sweetener composition at a weight ratio from about 0.3 to about 9 parts magnesium chloride on a dry basis to about 1 part synthetic sweetener.

In another particular embodiment, the at least one magnesium salt comprises magnesium sulfate. In one embodiment, the magnesium sulfate is present in the sweetener composition at a weight ratio from about 0.07 to about 19 parts magnesium sulfate on a dry basis to about 1 part synthetic sweetener. In another embodiment, the magnesium sulfate is present in the sweetener composition at a weight ratio from about 0.4 to about 11 parts magnesium sulfate on a dry basis to about 1 part synthetic sweetener.

In other particular embodiments, the sweetener compositions provided herein may further comprise at least one inorganic salt different than the at least one magnesium salt. Non-limiting examples of suitable inorganic salts include sodium chloride, potassium chloride, sodium sulfate, potassium sulfate, sodium phosphate, and potassium phosphate. In one embodiment, the at least one inorganic salt comprises sodium chloride, and the sodium chloride is present in the sweetener composition at a weight ratio from about 0.07 to about 14 parts sodium chloride on a dry basis to about 1 part synthetic sweetener.

Suitable uses for the sweetener compositions provided herein are well known to those of ordinary skill in the art. For example, the sweetener compositions may be used in place of conventional sweeteners in sweetened compositions, such as food, beverage, pharmaceutical, tobacco, nutraceutical, oral hygienic/cosmetic products, and the like. Sweetened compositions, as used herein, generally comprise a sweetener composition and a sweetenable composition.

The sweetener composition comprising the at least one synthetic sweetener may be present in the sweetened composition in an amount sufficient to impart a desired level of sweetness in the sweetened composition. In a particular embodiment, the at least one synthetic sweetener is present in the sweetened composition in an amount in the range of about 0.008 to about 0.075 weight percent of the sweetened composition. In one embodiment, the at least one magnesium salt is present in the sweetened composition in an amount from about 0.4 to about 12 mmol/kg. In another embodiment, the at least one magnesium salt is present in the sweetened composition in an amount from about 2.5 to about 7.5 mmol/kg. The sweetened composition optionally may further comprise at least one inorganic salt different than the at least one magnesium salt, wherein the at least one inorganic salt different than the at least one magnesium salt is present in the sweetened composition in an amount from about 0.8 to about 18 mmol/kg.

In a particular embodiment, the sweetened composition comprises a beverage, non-limiting examples of which include non-carbonated and carbonated beverages such as colas, ginger ales, root beers, ciders, fruit-flavored soft drinks (e.g., citrus-flavored soft drinks such as lemon-lime or orange), powdered soft drinks, and the like; fruit juices originating in fruits or vegetables, fruit juices including squeezed juices or the like, fruit juices containing fruit particles, fruit beverages, fruit juice beverages, beverages containing fruit juices, beverages with fruit flavorings, vegetable juices, juices containing vegetables, and mixed juices containing fruits and vegetables; sport drinks, energy drinks, near water and the like drinks (e.g., water with natural or synthetic flavorants); tea type or favorite type beverages such as coffee, cocoa, black tea, green tea, oolong tea and the like; beverages containing milk components such as milk beverages, coffee containing milk components, café au lait, milk tea, fruit milk beverages, drinkable yogurt, lactic acid bacteria beverages or the like; and dairy products.

Generally, the amount of synthetic sweetener present in a sweetened composition varies widely depending on the particular type of sweetened composition and its desired sweetness. Those of ordinary skill in the art can readily discern the appropriate amount of sweetener to put in the sweetened composition.

### EXAMPLES

### Example 1

A carbonated beverage is prepared comprising a sweetener composition comprising a combination of aspartame, acesulfame-K, sucralose, and magnesium chloride (Example 1A) or magnesium sulfate (Examples 1B and 1C) in a diluent such as carbonated water.

TABLE 1
Carbonated Beverages Having a Combination of Sweeteners

| Ingredients | Example 1A | Example 1B | Example 1C |
|---|---|---|---|
| Aspartame | 0.180 g | 0.180 g | 0.180 g |
| Sucralose | 0.050 g | 0.050 g | 0.050 g |
| Acesulfame-K | 0.150 g | 0.150 g | 0.150 g |
| Magnesium Chloride | 1.0 g | — | — |
| (MgCl₂6H₂O) | | | |
| Magnesium Sulfate | — | 1.2 g | 1.2 g |
| (MgSO₄7H₂O) | | | |
| Sodium Chloride | — | — | 0.4 g |
| Acidulant | 1.6 g | 1.6 g | 1.6 g |
| Preservative | 0.4 g | 0.4 g | 0.4 g |
| Flavor | 2.0 g | 2.0 g | 2.0 g |
| Total (with diluent) | 1000 g | 1000 g | 1000 g |

### Example 2

A carbonated beverage is prepared comprising a sweetener composition comprising a combination of acesulfame-K, sucralose, and magnesium chloride (Example 2A) or magnesium sulfate (Examples 2B and 2C) in a diluent such as carbonated water.

TABLE 2
Carbonated Beverages Having a Combination of Sweeteners

| Ingredients | Example 2A | Example 2B | Example 2C |
|---|---|---|---|
| Sucralose | 0.150 g | 0.150 g | 0.150 g |
| Acesulfame-K | 0.220 g | 0.220 g | 0.220 g |
| Magnesium Chloride | 1.0 g | — | — |
| (MgCl₂6H₂O) | | | |
| Magnesium Sulfate | — | 1.2 g | 1.2 g |
| (MgSO₄7H₂O) | | | |
| Sodium Chloride | — | — | 0.4 g |
| Acidulant | 1.0 g | 1.0 g | 1.0 g |
| Preservative | 0.4 g | 0.4 g | 0.4 g |
| Flavor | 2.0 g | 2.0 g | 2.0 g |
| Coloring | 0.4 g | 0.4 g | 0.4 g |
| Total (with diluent) | 1000 g | 1000 g | 1000 g |

### Example 3

A carbonated beverage was prepared comprising a sweetener composition comprising a combination of acesulfame-K and sucralose both with (Example 3B) and without (Example 3A) magnesium chloride in a diluent of carbonated water.

TABLE 3
Carbonated Beverages Having a Combination of Sweeteners

| Ingredients | Example 3A | Example 3B |
|---|---|---|
| Sucralose | 0.130 g | 0.130 g |
| Acesulfame-K | 0.200 g | 0.200 g |
| Magnesium Chloride | | 1.0 g |
| (MgCl₂ 6H₂O) | | |
| Acidulant | 1.0 g | 1.0 g |
| Flavor | 1.7 g | 1.7 g |
| Preservatives | 0.4 g | 0.4 g |
| Coloring | 0.4 g | 0.4 g |
| Carbonated Water | Adequate | Adequate |
| Total | 1 kg | 1 kg |

A sensory evaluation was made for each sample by tasting each sample at least 10 evaluators and by rating the after taste and body of the beverage. 6 of the 10 evaluators characterized the beverage with magnesium salt as having a good aftertaste while 0 of the 10 evaluators characterized the beverage without magnesium salt as having a good aftertaste. 5of the 10 evaluators characterized the beverage with magnesium salt as having good body while 0of the 10 evaluators characterized the beverage without magnesium salt as having good body.

### Example 4

A sweetener composition was prepared comprising combinations of aspartame, acesulfame-K, and sucralose. 5 evaluators made a sensory evaluation for each sample by tasting each sample and by comparing the taste and aftertaste of the sample to sugar. A summary of the results is provided in Table 4 below. Sweetener compositions having the most similar taste or aftertaste to sugar are denoted by ⊙ (as characterized by at least 3 evaluators), sweetener compositions having the least similar taste or aftertaste to sugar are denoted by \textcircled{×} (as characterized by no more than 1 evaluator), and sweetener compositions having a moderately similar taste or aftertaste to sugar are denoted by ◯ (as characterized by 2 evaluators.

TABLE 4
Sensory Evaluation of Combinations of Sweeteners

| | | | | | | | |
|---|---|---|---|---|---|---|---|
| Composition | Aspartame | 0.180 g | — | 0.180 g | — | 0.180 g | — |
| | Acesulfame-K | 0.150 g | 0.220 g | 0.150 g | 0.220 g | 0.150 g | 0.220 g |
| | Sucralose | 0.050 g | 0.150 g | 0.050 g | 0.150 g | 0.050 g | 0.150 g |
| | MgCl₂6H₂O | 1.0 g | 1.0 g | — | — | — | — |
| | MgSO₄7H₂O | — | — | 1.2 g | 1.2 g | — | — |
| | NaCl | — | — | 0.4 g | 0.4 g | — | — |
| Sensory | Similarity to | ⊚ | ⊚ | ◯ | ◯ | [symbol] | [symbol] |
| Evaluation | Sugar | | | | | | |
| | Aftertaste | ⊚ | ⊚ | ◯ | ◯ | [symbol] | [symbol] |

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

We claim:

1. A sweetener composition comprising:
at least one synthetic sweetener; and
at least one magnesium salt.

2. The sweetener composition of claim 1, wherein the at least one synthetic sweetener comprises aspartame, acesulfame-K, sucralose, or combinations thereof.

3. The sweetener composition of claim 1, wherein the at least one magnesium salt comprises magnesium chloride, magnesium sulfate, or combinations thereof.

4. The sweetener composition of claim 1, further comprising at least one inorganic salt different than the at least one magnesium salt.

5. The sweetener composition of claim 4, wherein the at least one inorganic salt comprises sodium chloride.

6. The sweetener composition of claim 1, wherein the at least one synthetic sweetener comprises a combination of aspartame, acesulfame-K, and sucralose.

7. The sweetener composition of claim 6, wherein the aspartame, acesulfame-K, and sucralose are present in the sweetener composition at a weight ratio from about 1 part aspartame to about 0.25 to about 2.0 parts acesulfame-K to about 0.25 to about 1.0 parts sucralose.

8. The sweetener composition of claim 6, wherein the at least one magnesium salt comprises magnesium chloride.

9. The sweetener composition of claim 8, wherein the magnesium chloride is present in the sweetener composition at a weight ratio from about 0.07 to about 15 parts magnesium chloride on a dry basis to about 1 part the total amount of the synthetic sweetener.

10. The sweetener composition of claim 6, wherein the at least one magnesium salt comprises magnesium sulfate.

11. The sweetener composition of claim 10, wherein the magnesium sulfate is present in the sweetener composition at a weight ratio from about 0.07 to about 19 parts magnesium sulfate on a dry basis to about 1 part the total amount of the synthetic sweetener.

12. The sweetener composition of claim 6, further comprising at least one inorganic salt different than the at least one magnesium salt.

13. The sweetener composition of claim 12, wherein the at least one inorganic salt comprises sodium chloride.

14. The sweetener composition of claim 13, wherein the sodium chloride is present in the sweetener composition at a weight ratio from about 0.07 to about 14 parts sodium chloride on a dry basis to about 1 part the total amount of the synthetic sweetener.

15. The sweetener composition of claim 1, wherein the at least one synthetic sweetener comprises a combination of acesulfame-K and sucralose.

16. The sweetener composition of claim 15, wherein the acesulfame-K and sucralose are present in the sweetener composition at a weight ratio from about 0.5 to about 3.0 parts acesulfame-K to about 1 part sucralose.

17. The sweetener composition of claim 15, wherein the at least one magnesium salt comprises magnesium chloride.

18. The sweetener composition of claim 17, wherein the magnesium chloride is present in the sweetener composition at a weight ratio from about 0.07 to about 15 parts magnesium chloride on a dry basis to about 1 part the total amount of the synthetic sweetener.

19. The sweetener composition of claim 15, wherein the at least one magnesium salt comprises magnesium sulfate.

20. The sweetener composition of claim 19, wherein the magnesium sulfate is present in the sweetener composition at a weight ratio from about 0.07 to about 19 parts magnesium sulfate on a dry basis to about 1 part the total amount of the synthetic sweetener.

21. The sweetener composition of claim 15, further comprising at least one inorganic salt different than the at least one magnesium salt.

22. The sweetener composition of claim 21, wherein the at least one inorganic salt comprises sodium chloride.

23. The sweetener composition of claim 22, wherein the sodium chloride is present in the sweetener composition at a weight ratio from about 0.07 to about 14 parts sodium chloride on a dry basis to about 1 part the total amount of the synthetic sweetener.

24. A sweetened composition comprising:
a sweetenable composition; and
the sweetener composition of claim 1.

25. The sweetened composition of claim 24, wherein the at least one magnesium salt is present in the sweetened composition in an amount in the range of about 0.4 to about 12 mmol/kg.

26. The sweetened composition of claim 24, wherein the at least one synthetic sweetener comprises aspartame, acesulfame-K, sucralose, or combinations thereof.

27. The sweetened composition of claim 24, wherein the at least one magnesium salt comprises magnesium chloride, magnesium sulfate, or combinations thereof.

28. The sweetened composition of claim 24, further comprising at least one inorganic salt different than the at least one magnesium salt.

29. The sweetened composition of claim 28, wherein the at least one inorganic salt comprises sodium chloride.

30. The sweetened composition of claim 24, wherein the at least one synthetic sweetener comprises a mixture of aspartame, acesulfame-K, and sucralose.

31. The sweetened composition of claim 30, wherein the aspartame, acesulfame-K, and sucralose are present in the sweetener composition at a weight ratio from about 1 part aspartame to about 0.25 to about 2.0 parts acesulfame-K to about 0.25 to about 1.0 parts sucralose.

32. The sweetened composition of claim 30, wherein the at least one magnesium salt comprises magnesium chloride.

33. The sweetened composition of claim 32, wherein the magnesium chloride is present in the sweetener composition at a weight ratio from about 0.07 to about 15 parts magnesium chloride to about 1 part the total amount of the synthetic sweetener.

34. The sweetened composition of claim 32, wherein the magnesium chloride is present in the sweetened composition in an amount in the range of about 0.4 to about 12 mmol/kg.

35. The sweetened composition of claim 30, wherein the at least one magnesium salt comprises magnesium sulfate.

36. The sweetened composition of claim 35, wherein the magnesium sulfate is present in the sweetener composition at a weight ratio from about 0.07 to about 19 parts magnesium sulfate to about 1 part the total amount of the synthetic sweetener.

37. The sweetened composition of claim 35, wherein the magnesium sulfate is present in the sweetened composition in an amount in the range of about 0.4 to about 12 mmol/kg

38. The sweetened composition of claim 30, wherein the sweetener composition further comprises at least one inorganic salt different than the at least one magnesium salt.

39. The sweetened composition of claim 38, wherein the at least one inorganic salt comprises sodium chloride.

40. The sweetened composition of claim 39, wherein the sodium chloride is present in the sweetener composition at a weight ratio from about 0.07 to about 14 parts sodium chloride to about 1 part the total amount of the synthetic sweetener.

41. The sweetened composition of claim 38, wherein the at least one inorganic salt different than the at least one magnesium salt is present in the sweetened composition in an amount in the range of about 0.8 to about 18 mmol/kg.

42. The sweetened composition of claim 24, wherein the at least one synthetic sweetener comprises a combination of acesulfame-K and sucralose.

43. The sweetened composition of claim 42, wherein the acesulfame-K and sucralose are present in the sweetener composition at a weight ratio from about 0.5 to about 3.0 parts acesulfame-K to about 1 part sucralose.

44. The sweetened composition of claim 42, wherein the at least one magnesium salt comprises magnesium chloride.

45. The sweetened composition of claim 42, wherein the magnesium chloride is present in the sweetener composition at a weight ratio from about 0.07 to about 15 parts magnesium chloride to about 1 part the total amount of the synthetic sweetener.

46. The sweetened composition of claim 44, wherein the magnesium chloride is present in the sweetened composition in an amount in the range of about 0.4 to about 12 mmol/kg

47. The sweetened composition of claim 42, wherein the at least one magnesium salt comprises magnesium sulfate.

48. The sweetened composition of claim 47, wherein the magnesium sulfate is present in the sweetener composition at a weight ratio from about 0.07 to about 19 parts magnesium sulfate to about 1 part the total amount of the synthetic sweetener.

49. The sweetened composition of claim 47, wherein the magnesium sulfate is present in the sweetened composition in an amount in the range of about 0.4 to about 12 mmol/kg.

50. The sweetened composition of claim 42, wherein the sweetener composition further comprises at least one inorganic salt different than the at least one magnesium salt.

51. The sweetened composition of claim 50, wherein the at least one inorganic salt comprises sodium chloride.

52. The sweetened composition of claim 51, wherein the sodium chloride is present in the sweetener composition in an amount in the range of about 0.005 to about 0.1 percent by weight.

53. The sweetened composition of claim 50, wherein the at least one inorganic salt different than the magnesium salt is present in the sweetened composition in an amount in the range of about 0.8 to about 18 mmol/kg.

54. The sweetened composition of claim 24, wherein the sweetened composition comprises a food, beverage, pharmaceutical, tobacco, nutraceutical, oral hygienic, or cosmetic.

55. A beverage comprising the sweetened composition of claim 24.

56. The beverage of claim 55, wherein the at least one magnesium salt is present in the beverage in an amount in the range of about 0.4 to about 12 mmol/kg.

57. The beverage of claim 55, wherein the beverage further comprises at least one inorganic salt different than the at least one magnesium salt in the beverage in an amount from about 0.8 to about 18 mmol/kg.

58. The beverage of claim 55, wherein the beverage is a non-carbonated beverage or a carbonated beverage.

59. The beverage of claim 58, wherein the carbonated beverage is a cola.

60. The beverage of claim 58, wherein the beverage is a fruit-flavored beverage.

61. The beverage of claim 58, wherein the beverage is a citrus-flavored beverage.

62. The beverage of claim 61, wherein the citrus-flavored beverage is a lemon-lime flavored beverage or a orange-flavored beverage.

63. The beverage of claim 58, wherein the carbonated beverage is a root beer.

64. The beverage of claim 55, wherein the beverage is a fruit juice, fruit-flavored, or fruit-containing beverage.

65. The beverage of claim 55, wherein the beverage is a vegetable juice or vegetable containing beverage.

66. The beverage of claim 55, wherein the beverage is tea.

67. The beverage of claim 55, wherein the beverage is coffee.

68. The beverage of claim 55, wherein the beverage comprises a dairy component.

69. The beverage of claim 55, wherein the beverage is a sports drink.

70. The beverage of claim 55, wherein the beverage is an energy drink.

71. The beverage of claim 55, wherein the beverage is a flavored water.
